(19) United States
(12) Patent Application Publication
(10) Pub. No.: US 2026/0180452 A1
(43) Pub. Date: Jun. 25, 2026

(54) CASCADED TWO-STAGE POWER CONVERTER WITH OPTIMIZED THERMAL DESIGN AND MULTI-PHASE POWER SUPPLY SYSTEM INCLUDING THE SAME

(71) Applicant: Monolithic Power Systems, Inc., Kirkland, WA (US)

(72) Inventor: Pengjie Lai, Cupertino, CA (US)

(21) Appl. No.: 19/397,445

(22) Filed: Nov. 21, 2025

Related U.S. Application Data
(60) Provisional application No. 63/726,377, filed on Nov. 29, 2024.

(51) Int. Cl. H02M 3/158

(52) U.S. Cl. CPC H02M 3/1586

(57) ABSTRACT

An integrated circuit comprises: a first stage circuit, a second stage circuit, a sync communication module, and an I/O communication module. The first stage circuit is configured to receive a first stage input voltage through a first stage input terminal, and divide the first stage input voltage to generate a first stage output voltage. The second stage circuit is configured to receive the first stage output voltage through a second stage input terminal, and regulates the first stage output voltage to generate a second stage output voltage. The sync communication module is configured to be operable for coupling to a sync communication module of the another integrated circuit in the multi-phase power supply system, and to share a reference clock signal with the other integrated circuits. The I/O communication module, configured to be operable for communicating with a host controller.

### CROSS-REFERENCE TO RELATED APPLICATION(S)

The present application claims priority to, and the benefit of, U.S. Provisional Patent Application No. 63/726,377 , filed on Nov. 29, 2024, which is incorporated herein by reference in its entirety.

### TECHNICAL FIELD

The present disclosure is directed generally to electrical circuits, and more particularly but not exclusively to cascaded two-stage power converter with optimized thermal design and multi-phase power supply system including multiple of the two-stage power converters.

### BACKGROUND

Conventional voltage regulator designs typically involve a single-stage architecture. In such designs, power MOSFETs are required to accommodate the full input voltage range plus a safety margin. This constraint can result in the use of power MOSFETs with higher resistance and lower efficiency, negatively impacting the overall figure of merit. Additionally, the voltage drop across inductors tends to be higher, reducing system efficiency. Furthermore, thermal stress is concentrated in specific areas of the system rather than being distributed.

### SUMMARY

In one embodiment, an integrated circuit for a switching power supply is used in a multi-phase power supply system comprising a plurality of the integrated circuits. The integrated circuit includes: a first stage input terminal, a first stage output terminal, a second stage input terminal, a first stage circuit, a second stage circuit, a sync communication module, and I/O communication module. The first stage input terminal is configured to receive a first stage input voltage. The first stage output terminal is configured to output a first stage output voltage that is lower than the first stage input voltage, wherein the first stage output terminal is configured to be operable for coupling to first stage output terminals of other integrated circuits in the multi-phase power supply system. The second stage input terminal is configured to be operable for coupling to the first stage output terminal. The first stage circuit is configured to receive the first stage input voltage through the first stage input terminal, and divide the first stage input voltage to generate the first stage output voltage. The second stage circuit is configured to receive the first stage output voltage through the second stage input terminal, and regulates the first stage output voltage to generate a second stage output voltage. The sync communication module is configured be operable for coupling to a sync communication module of another integrated circuit of the plurality of the integrated circuits in the multi-phase power supply system, and to synchronize a clock signal with the another integrated circuit. The I/O communication module is configured to be operable for communicating with a host controller.

A multi-phase power supply system including a plurality of integrated circuits. Each of the integrated circuits includes a first stage input terminal, a first stage output terminal, a second stage input terminal, a first stage circuit, a second stage circuit, a sync communication module, and I/O communication module. The first stage input terminal is configured to receive a first stage input voltage. The first stage output terminal is configured to output a first stage output voltage that is lower than the first stage input voltage, wherein the first stage output terminal is configured to be operable for coupling to first stage output terminals of other integrated circuits in the multi-phase power supply system. The second stage input terminal is configured to be operable for coupling to the first stage output terminal. The first stage circuit is configured to receive the first stage input voltage through the first stage input terminal, and divide the first stage input voltage to generate the first stage output voltage. The second stage circuit is configured to receive the first stage output voltage through the second stage input terminal, and regulates the first stage output voltage to generate a second stage output voltage. The sync communication module is configured be operable for coupling to a sync communication module of another integrated circuit of the plurality of the integrated circuits in the multi-phase power supply system, and to synchronize a clock signal with the another integrated circuit. The I/O communication module is configured to be operable for communicating with a host controller.

These and other features of the present disclosure will be readily apparent to persons of ordinary skill in the art upon reading the entirety of this disclosure, which includes the accompanying drawings and claims.

### BRIEF DESCRIPTION OF DRAWINGS

A more complete understanding of the subject matter may be derived by referring to the detailed description and claims when considered in conjunction with the following figures, wherein like reference numbers refer to similar elements throughout the figures.

FIG. 1 shows a schematic diagram of a power converter 100, in accordance with an embodiment of the present invention.

FIG. 2A shows a schematic diagram of a single-phase charge pump, in accordance with an embodiment of the present invention.

FIG. 2B shows a schematic diagram of a multiphase charge pump, in accordance with an embodiment of the present invention.

FIG. 3 illustrates a schematic diagram of a power converter 300, in accordance with an embodiment of the present invention.

FIG. 4 illustrates a schematic diagram of a multi-phase power supply system 400, in accordance with an embodiment of the present invention.

FIG. 5 illustrates a schematic diagram of a multi-phase power supply system 500, in accordance with another embodiment of the present invention.

FIG. 6 illustrates a schematic diagram of a power converter IC 600, in accordance with another embodiment of the present invention.

### DETAILED DESCRIPTION

Hereinafter, specific embodiments of the present invention will be described in detail, and it should be noted that the embodiments described herein are only for illustration and are not intended to limit the present invention. In the following description, numerous specific details are set forth in order to provide a thorough understanding of the present invention. However, it will be apparent to one having ordinary skills in the art that these specific details are not necessary to practice the present invention. In other instances, well-known circuits, materials or methods are not described in detail in order to avoid obscuring the present invention.

Throughout this specification, references to “one embodiment”, “an embodiment”, “one example” or “an example” mean that a particular feature, structure or characteristic described in connection with this embodiment or example is included in embodiment of the present invention. Therefore, the phrases “in one embodiment”, “in an embodiment”, “one example” or “an example” appearing in various places throughout the specification do not necessarily all refer to the same embodiment or example. Furthermore, specific features, structures or characteristics may be combined in any suitable combination and/or sub-combination in one or more embodiments or examples. Furthermore, it should be understood by those skilled in the art that the drawings provided herein are for illustration purposes and are not necessarily drawn to scale. When an element is said to be “coupled” or “connected” to another element, it may be directly coupled or connected to another element, or an intervening element may be present therebetween. Conversely, when an element is said to be “directly coupled” or “directly connected” to another element, there are no intervening elements. Like reference numerals indicate like elements. The term “and/or” as used herein includes any and all combinations of one or more related listed items.

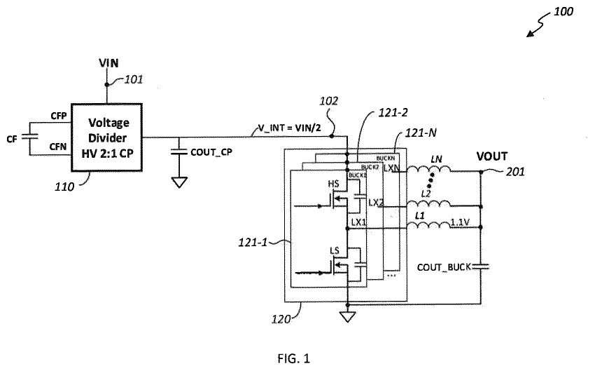

FIG. 1 shows a schematic diagram of a power converter 100, in accordance with an embodiment of the present invention.

The power converter 100 includes a first stage circuit 110 and a second stage circuit 120. In the example of FIG. 1, the first stage circuit 110 includes a voltage divider in the form of a charge pump, and the second stage circuit 120 includes a multiphase voltage regulator.

The first stage circuit 110 receives the input voltage VIN at a node 101 and outputs an intermediate voltage V_INT at a node 102. In an embodiment, the first stage circuit 110 may function as a voltage divider to generate a smaller intermediate voltage V_INT from a larger input voltage VIN. In an embodiment, the intermediate voltage V_INT is half of the input voltage VIN. The intermediate voltage V_INT is connected as an input voltage to the second stage circuit 120. The second stage circuit 120 regulates the intermediate voltage V_INT to the output voltage VOUT at a node 201.

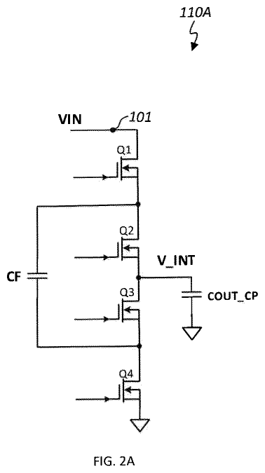

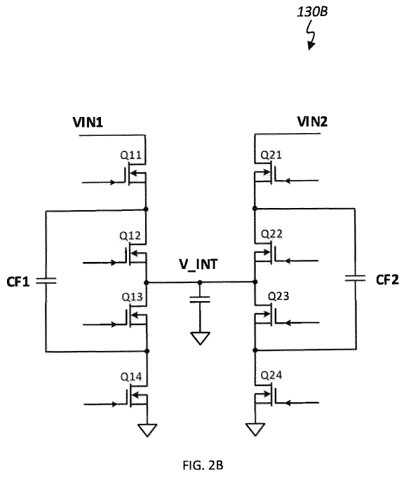

The charge pump 110 may be a single-phase or multiphase charge pump. FIG. 2A shows a schematic diagram of a single-phase charge pump 110A, in accordance with an embodiment of the present invention. As shown in FIG. 2A, the charge pump 110A includes four switches (i.e., a first switch Q1, a second switch Q2, a third switch Q3, and a fourth switch Q4) connected in series between the node 101 and a reference ground and a flying capacitor CF. The flying capacitor CF is coupled between a common node of the first switch Q1 and the second switch Q2 and a common node of the third switch Q3 and the fourth switch Q4. The first stage circuit 110 shown in FIG. 1 is a charge pump in single phase. However, the first stage circuit 110 may also be multi-phase configurations. FIG. 2B shows a schematic diagram of a multiphase charge pump 110B, which includes two repeated single-phase configurations as shown in FIG. 2A.

The switches of the charge pump operate in responsive to clock signals received from a clock module (not shown). For example, during one half of a clock cycle, certain ones of the switches are turned on and others are turned off. For example, for the charge pump shown in FIG. 2A, switching states of the first switch Q1 and the third switch Q3 can be the same, and switching states of the second switch Q2 and the fourth switch Q4 can be the same and complementary to that of the first switch Q1 and the third switch Q3.

Referring back to FIG. 1, the second stage circuit 120 includes a multiphase voltage regulator, including buck converters 121-X (i.e., 121-1, 121-2, . . . , 121-N). In an embodiment, the N≥2. Each buck converter 121-X includes a buck controller (not shown in FIG. 1), a switching circuit (e.g., including a high-side switch HS and a low-side switch LS), and an output inductor L (i.e., L1, L2, . . . , LN) that connects switch node LX (i.e., LX1, LX2, . . . , LXN) to an output voltage VOUT at the node 201, and a buck output capacitor COUT_BUCK for smoothing and filtering the output voltage VOUT. The buck controller controls the high-side switch HS and the low-side switch HS to be turned on and off complementary, to regulate a current flowing through the corresponding inductor, so as to convert the intermediate voltage V_INT to the output voltage VOUT at the node 201.

In an embodiment, the voltage divider 110 is configured to lower the input voltage by ½ (IE from 12V down to 6V). Therefore, compared with the traditional one-stage multiphase voltage regulator, the second stage circuit 120 now may use lower voltage rated power MOSFETs, thereby increasing efficiency. Also, the lower input voltage for the buck converter means voltage across inductors during magnetization phase is reduced significantly (IE from 10.9V (12-1.1) to 4.9V (6-1.1), which lowers ripple and reduces AC power losses on the inductors.

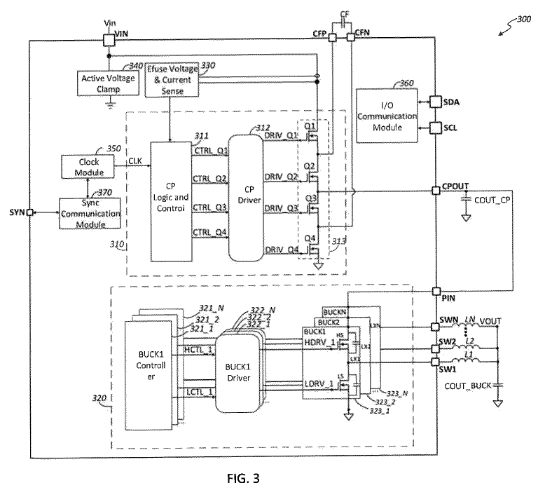

FIG. 3 illustrates a schematic diagram of a power converter 300, in accordance with an embodiment of the present invention.

As shown in FIG. 3, the power converter 300 includes a first stage circuit 310, a second stage circuit 320, an eFuse 330, an active voltage clamp 340, a CP clock module 350, an I/O communication module 360, and a sync communication module 370.

The first stage circuit 310 and the second stage circuit 320 are embodiments of the first stage circuit 110 and the second stage circuit 120 shown in FIG. 1. In an embodiment, the power converter 300 may be integrated and implemented as a power management integrated circuit (PMIC) or a standalone voltage regulator in the form of a single-purpose integrated circuit (IC) with necessary components being external to the IC. These external components can include capacitors (e.g., a flying capacitor CF, a CP output capacitor COUT_CP and a buck output capacitor COUT_BUCK) and inductors (e.g., inductors L1, L2, . . . LN) among other necessary components.

The first stage circuit 310 receives an input voltage (e.g., also referred to as a first stage input voltage) at an input terminal VIN (e.g., also referred to as a first stage input terminal VIN) by way of an eFuse 330, divides the input voltage Vin to a lower intermediate voltage V_INT (e.g., also referred to as a first stage output voltage) and outputs the intermediate voltage V_INT at a terminal CPOUT (e.g., also referred to as a first stage output terminal CPOUT). An active voltage clamp 340 clamps the input voltage VIN at a predetermined voltage level.

The eFuse 330 includes a current sense circuit for monitoring a current through the first stage circuit 310. The eFuse 330 disconnects the input voltage VIN from the first stage 310 when the current through the eFuse 330 exceeds a threshold. The power converter 300 can provide current clamp function and voltage clamp function in addition to disconnection function to prevent system board damage in the event of corner cases.

The disconnection function of the eFuse 330 may be implemented in a variety of ways. For example, the eFuse 330 may include a switch (e.g., MOSFET) that is in series between the input voltage VIN and the first stage 310. The switch is normally closed, and opens in response to detecting overvoltage and/or overcurrent. The eFuse 330 may also include an active clamp that shunts energy to ground responsive to detecting overvoltage. Deploying the eFuse 330 close to the input voltage VIN enhances input voltage-related protection. The eFuse 330 and the active voltage clamp 340 allow the first stage circuit 310 to accommodate a wide range of input voltages, e.g., 3.3V to 48V, to meet the requirements of various applications. The eFuse 330 functionality may also include slew rate control functionality. That is, the eFuse 330 may be configured to provide the input voltage VIN to the first stage 310 such that the input voltage VIN is reflected on the output of the first stage 310 in a slew-rate controlled manner.

As shown in FIG. 3, the first stage circuit 310 includes a CP logic and control circuit 311, a CP driver 312 and a CP switching circuit 313.

The CP logic and control circuit 311 controls the switching operation of the charge pump 310 based on a clock signal CLK provided by the CP clock module 350. For example, during one half of a clock cycle, certain ones of the switches of the charge pump 310 are turned on and others are turned off. The open and off states for the switches then reverse for the remaining half of the clock cycle. In an embodiment, the clock module 350 may include a clock generator (such as an oscillator) and a clock shifter. The CP logic and control circuit 311 may generate switch control signals CTRL_Q1, CTRL_Q2, CTRL_Q3, and CTRL_Q4, for controlling the turn-on and turn-off of the switches Q1-Q4. The CP logic and control circuit 311 may also provide added functionality to enable/disable the power converter, provide a power good signal, etc.

The CP driver 312 is configured to generate driving signals DRIV_Q1-DRIV_Q4 based on the switch control signals CTRL_Q1-CTRL_Q4, respectively. The CP driver 312 enhances the driving capability of the corresponding switch control signals. Ideally, when the system is in a stable operation state, the driving signals DRIV_Q1-DRIV_Q4 are synchronized/consistent with the corresponding switch control signals CTRL_Q1-CTRL_Q4.

The second stage circuit 320 receives the intermediate voltage V_INT generated by the first stage circuit 310 at a power input terminal PIN (e.g., also referred to as a second stage input terminal), and converts the intermediate voltage V_INT to a regulated output voltage VOUT (e.g., also referred to as a second stage output voltage VOUT). The second stage circuit 320 includes a multiple-phase buck converter. Each phase includes a buck controller 321_X (i.e., 321_1, 321_2, . . . , 321_N), a buck driver 322_X (i.e., 322_1, 322_2, . . . , 322_N) and a switching circuit 323_X (i.e., 323_1, 323_2, . . . , 323_N, each including a high-side switch HS and a low-side switch LS), and connects to an output inductor LX (i.e., L1, L2, . . . , LN) and a buck output capacitor COUT_BUCK through a switching terminal SWX (i.e., SW1, SW2, . . . , SWN) to generate the output voltage VOUT. The buck controller 321_X controls the high-side switch HS and the low-side switch HS in each phase to be turned on and off complementary, to regulate a current flowing through the corresponding inductor LX. As such, the multiphases jointly convert the intermediate voltage V_INT to the output voltage VOUT. Specifically, each of the buck controllers 321_X may generate a high-side switching control signal HCTL_X (e.g., HCTL_1, HCTL_2, . . . , HCTL_N) and a low-side switching control signal LCTL_X (e.g., LCTL_1, LCTL_2, . . . , LCTL_N) based on a feedback signal being indicative of the output voltage VOUT. In an embodiment, the switching control signals are pulse-width modulation (PWM) signals. In the embodiment of PWM control methods such as voltage control and current control, the buck controller 321_X can amplify the difference between the feedback signal and a reference signal, and then compare the difference amplified signal with a ramp signal to generate the switching control signals. In an embodiment, the buck controllers 321_X may operate in a critical conduction mode with a constant on-time (COT) control.

It should be understood that the buck controllers 321_X can be implemented by any suitable control mode and circuit structure as long as it can control the power level. The application does not limit the topology and control mode of the buck controllers.

Each of the buck drivers is 322_X is configured to generate a high-side driving signal HDRV_X (e.g., HDRV_1, HDRV_2, . . . , HDRV_N) based on the corresponding high-side switching control signal HCTL_X and a low-side driving signal LDRV_X based on the corresponding low-side switching control signal LCTL_X. The buck driver 322_X enhances the driving capability of the high-side switching control signal HCTL_X and the low-side switching control signal LCTL_X, respectively (i.e., by increasing the amplitude differences between their logic high and low levels). Ideally, when the system is in a stable operation state, the high-side driving signal HDRV_X and the low-side driving signal LDRV_X are synchronized/consistent with the logic states of the corresponding high-side switching control signal HCTL_X and low-side switching control signal LCTL_X, respectively.

The I/O communication module 360 is configured to communicate with another device (for example, a host controller). The I/O communication module 360 may include, a UART (universal asynchronous receiver-transmitter) communication module, an SPI communication module (serial peripheral interface), an I2C/I3C communication module, among others. In the example shown in FIG. 3, the I/O communication module 360 is an I2C/I3C communication module, which can communicate with the another device (for example, a host controller) through a pair of terminals SDA and SCL, and based on the I2C/I3C protocol.

The two-stage power converter can provide many advantages. First, the separated two stages with distributed thermal on one design form factor relieves the thermal stress on the design board. Second, the first stage circuit has the eFuse close to the power inlet, enabling system board input voltage-related protection and consolidating the reliability of the design. The first stage circuit can cover different voltages from 3.3V to 48V depending on the application. Third, the first stage circuit with integrated charge pump structure minimizes power loss and improves the thermal stress. Fourth, the second stage circuit with lower input voltage enables use of low voltage devices to maximize the efficiency performance of the whole solution. Fifth, disposing the second stage circuit close to the load side enables better local load regulation performance.

In the occasions of in large power and large current conditions, it has become a common practice to interleave multiple discrete power converter ICs or the individual converter stages within them. Such configuration is called multi-phase power supply system.

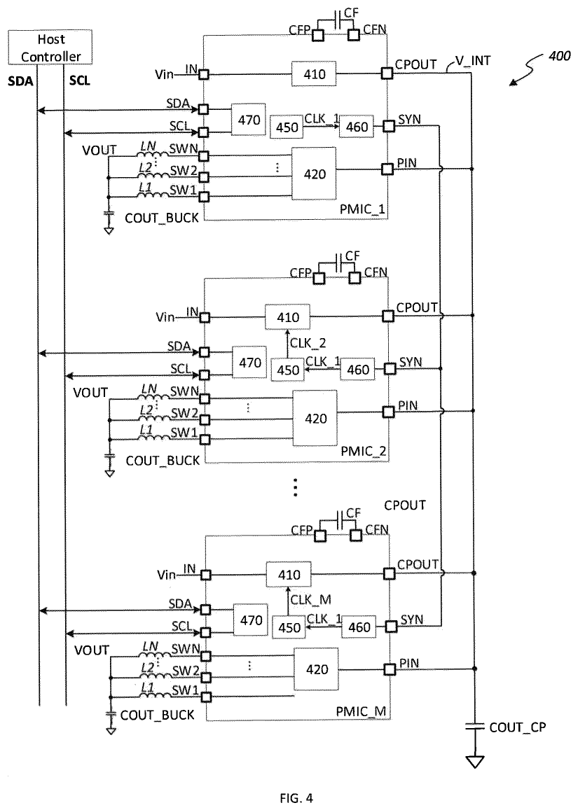

FIG. 4 illustrates a schematic diagram of a multi-phase power supply system 400, in accordance with an embodiment of the present invention.

As shown in FIG. 4, the multi-phase power supply system 400 includes multiple power converter ICs connected in parallel. For example, each of the power converter ICs may be a Power Management Integrated Circuit (PMIC). As shown in FIG. 4, the multi-phase power supply system 400 includes PMIC-1, PMIC-2, . . . , and PMIC-M. In an embodiment, the M≥2. In an embodiment, the PMICs PMIC_1-PMIC_M have the same structure. In an embodiment, the PMIC-X (e.g., PMIC-1, PMIC-2, . . . , or PMIC-M) can be an embodiment of the power converter 300 depicted in FIG. 3.

As shown in FIG. 4, the PMIC_X includes a first stage circuit 410, a second stage circuit 420, a clock module 450, a sync communication module 460, an I/O communication module 460, and a set of terminals IN, CFP, CFN, CPOUT, SYN, PIN, SDA, SCL and SW1, SW2, . . . , SWN. The PMIC-X may include several other functional units or modules that perform respective functions. Those functional units or modules are not illustrated and described herein in order to not obscure the subject matter of the present embodiment.

The first stage circuit 410 receives an input voltage Vin from the terminal VIN, and outputs an intermediate voltage V_INT at the terminal CPOUT. The second stage circuit 420 receives the intermediate voltage V_INT output by the first stage circuit 410 from the terminal PIN, and convert the intermediate voltage V_INT to an output voltage VOUT. As shown in FIG. 4, in an embodiment, the terminals CPOUT of all the PMICs are coupled together to provide the intermediate voltage V_INT. In an embodiment, a shared capacitor COUT_CP is coupled to the common output node.

In order to reduce ripples on the output current, and enable the use of smaller, physically lighter capacitors (such as the shared capacitor COUT_CP, and the flying capacitor on each PMIC), the present application proposes a method to precisely synchronize the switching cycles of the first-stage switches within each PMIC of the system 400.

In an embodiment, a host controller may typically communicate with each PMIC individually over a digital communication bus, such as I2C or SPI through the corresponding I/O communication module 470 in each PMIC. In an embodiment, the host controller is often integrated within the System-on-Chip (SoC) or the main Microprocessor (MPU)/processor. As an example, the I/O communication module 470 shown in FIG. 4 is an I2C/I3C communication module, which can communicate with the host controller through a pair of terminals SDA and SCL based on I2C/I3C protocol.

The host controller may send a first signal to inform each PMIC a total number M of the PMICs (i.e., a value of M) of the system 400. In an embodiment, the host controller may write the value of M into a first dedicated, volatile configuration register (not shown) within each PMIC. The control logic (not shown) in each of the PMICs may calculate a phase difference (e.g., 360°/M, where M is the total PMIC count) between every two adjacent clocks based on the total number M of PMICs in the system. In another embodiment, the host controller may also directly send the phase difference to each of the PMICs.

In an embodiment, the host controller may further send a second signal to inform each of the PMICs a rank/index (e.g., ‘1’, ‘2’, . . . , or ‘M’) of each PMIC. In an embodiment, the host controller may write the rank/index for each PMIC into a second dedicated, volatile configuration register (not shown) within each PMIC. This rank/index is an identification mark used to distinguish each PMIC. It should be understood that the rank/index can correspond to the physical connection order of each IC, or it can be independent and irrelevant. In another embodiment, the value of M (or the phase difference) and the rank/index for each PMIC are typically programmed into a non-volatile memory register (e.g., an internal EEPROM or flash memory) within each PMIC. For example, a user (such as a manufacturer during production testing or development) utilizes a specific hardware or software user communication module (often a JTAG port, a proprietary programming tool, or even simple physical configuration pins/jumpers on the PCB) to write the desired parameters into the register. Once received the reference clock CLK_1 from the master PMIC, the clock modules in each of the slave devices may calculate its local clock by shifting the received reference clock CLK_1 to its corresponding local clock (e.g., CLK_2, CLK_3, . . . , CLK_M).

In an embodiment, the PMIC with the rank/index of ‘1’ may be set as the master device, and the other PMICs with the rank/index of ‘2’, . . . , or ‘M’ are set as the slave devices. In the embodiment shown in FIG. 4, the first PMIC (e.g., PMIC_1) may function as a master device and the other PMICs (e.g., PMIC_2, PMIC_3, . . . , PMIC_M) may function as slave devices. In other embodiment, a PMIC with another rank/index (e.g., ‘2’) may be set as the master device while the rest of the PMICs are set as the slave devices. The present application is not limited thereto.

In the stable state, the switching frequency and phase of the switches of the first stage circuit 410 in each PMICs are equal to their local clocks CLK_1, CLK_2, CLK_3, . . . , CLK_M. In an embodiment, the clocks CLK_1, CLK_2, CLK_3, . . . , CLK_M are a group of clock signals that share the same frequency and exhibit a uniform, sequential phase difference. For example, when M equals to 2, the phase difference between the clocks CLK_1 and CLK_2 are 180°. When M equals to 3, a phase difference between the clocks CLK_1 and CLK_2 are 120°, and a phase difference between the clocks CLK_2 and CLK_3 are 120°, and so on.

The PMIC_1 (or a clock module 450 therein) may generate a reference clock CLK_1, and synchronize the reference clock CLK_1 with the slave devices through corresponding sync communication modules 460 and communication terminals SYN to the other slave PMICs. As mentioned previously in FIG. 3, the clock module 450 may include a clock generator (such as an oscillator) and a clock shifter. When a PMIC (i.e., PMIC_1) is set as the master device (i.e., the rank/index of ‘1’ is assigned), the clock generator in the master device is enabled to generate the reference clock CLK_1 and the clock shifter is disabled.

Each of the slave devices receives the reference clock CLK_1 via its respective communication module (e.g., 460) and SYN terminal. When a PMIC (i.e., PMIC_2, PMIC_3, . . . , PMIC_M) is set as the slave device (i.e., the rank/index of ‘2’, . . . , or ‘M’ are assigned), the clock generator in the slave device is disabled and the clock shifter is enabled to shift the reference clock signal to generate a local clock signal. In an embodiment, the clock shifter shifts the received reference clock CLK_1 to generate its local clock (e.g., CLK_2, CLK_3, . . . , CLK_M) based on the phase difference and its rank/index. For example, in a scenario where M equals to 4, the phase difference is 90°. The first PMIC uses CLK_1, the second PMIC (i.e., PMIC_2) may shift CLK_1 by 90°, the third PMIC (i.e., PMIC_3) may shift CLK_1 by 180°, and fourth PMIC (i.e., PMIC_4) may shift CLK_1 by 270°.

This method ensures precise, synchronized, and staggered operation across all PMICs in the multiphase configuration.

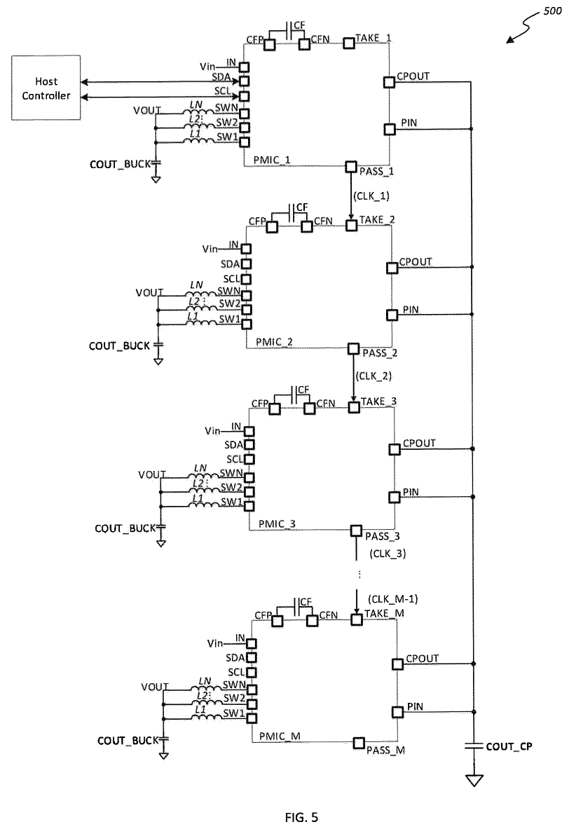

FIG. 5 illustrates a schematic diagram of a multi-phase power supply system 500, in accordance with another embodiment of the present invention.

As shown in FIG. 5, the multi-phase power supply system 500 includes M PMICs connected in a stacked or sequential manner, and can communicate with each other in a daisy-chain manner. The PMICs are linked one after another. For example, as shown in FIG. 4, the second PMIC (e.g., PMIC_2) connects to the first PMIC (e.g., PMIC_1), the third PMIC (e.g., PMIC_3) connects to the second PMIC (e.g., PMIC_2), and so on. In an embodiment, the PMICs PMIC_1-PMIC_M have the same structure. As shown in FIG. 5, the terminals CPOUT of all the PMICs are coupled together to provide the intermediate voltage V_INT. In an embodiment, a shared capacitor COUT_CP is coupled to the common output node.

In an embodiment, the first PMIC (e.g., PMIC_1) may function as a master device and the other PMICs (e.g., PMIC_2, PMIC_3, . . . , PMIC_M) may function as slave devices.

The master device connects to a host controller and can directly communicate with the host controller. For example, in the example shown in FIG. 5, the master device may communicate with the host controller based on an I2C/I2C protocol and through a pair of terminals SDA and SCL. The host controller may send a signal to the PMIC_1 to inform the total number M of the PMICs (i.e., a value of M) in the system. The control logic (not shown) in the PMIC_1 may calculate a phase difference (e.g., 360°/M, where M is the total PMIC count) between every two adjacent clocks based on the total number of PMICs in the system. For example, in a scenario where M equals to 4, the phase difference is 90°. In another embodiment, the host controller may also directly send the phase difference to the PMIC_1.

In an embodiment, the PMIC_1 may store the phase difference in a dedicated, volatile configuration register in the PMIC_1 and transmit the phase difference to the next slave device (e.g., PMIC_2) adjacently coupled to the PMIC_1 through a terminal PASS_1. Similarly, the PMIC_2 can receive the phase difference through a terminal TAKE_2, store the phase difference a dedicated, volatile configuration register in the PMIC_2 and transmit the phase difference to the next slave device (e.g., PMIC_3) adjacently coupled to the PMIC_2 through a terminal PASS_2, and so on, until every PMIC is aware of the phase difference between its local clock and the clocks of both its preceding and succeeding adjacent PMICs in the chain.

In an embodiment, during normal operation of the power supply system 500, the PMIC_1 (or a clock module therein) may generate a reference clock CLK_1, and use the clock CLK_1 to control operation of the switches of the first stage circuit in the PMIC_1. The PMIC_1 then transmits the clock CLK_1 to the next PMIC (i.e., PMIC_2) through the terminal PASS_1. The PMIC_2 receives a preceding local clock (i.e., CLK_1) of the preceding PMIC (i.e., PMIC_1) through the terminal TAKE_2, and generates its own local clock CLK_2 by shifting the phase of the received PMIC_1 clock signal according to the phase difference. The PMIC_2 uses the clock CLK_2 to control the switching of its first-stage circuit's switches and transmits the clock CLK_2; this clock subsequently sent to the next PMIC (e.g., PMIC_3) via the terminal PASS_2. Similarly, the PMIC_3 can receive a preceding local clock (i.e., CLK_2) of the preceding PMIC (i.e., PMIC_2) through a terminal TAKE_3, and generates its own local clock CLK_3 by shifting the phase of the received PMIC_2 clock signal according to the phase difference, and so on. As such, the last PMIC (i.e., PMIC_M) can receive a preceding local clock (i.e., CLK_M-1) of the preceding PMIC (i.e., PMIC_M-1) through a terminal TAKE_M, and generates its own local clock CLK_M by shifting the phase of the received PMIC_M-1 clock signal according to the phase difference.

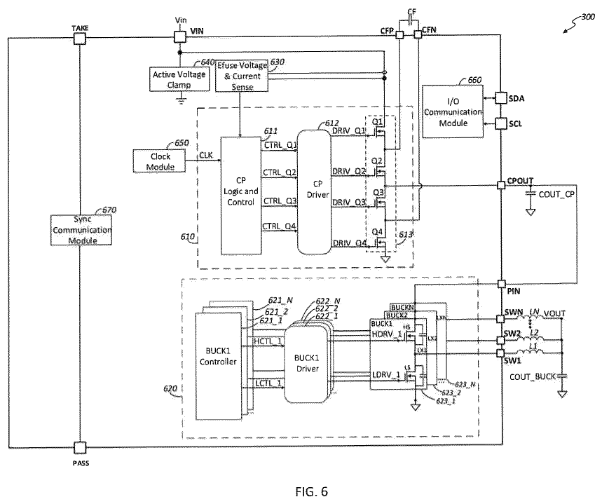

FIG. 6 illustrates a schematic diagram of a power converter IC 600, in accordance with another embodiment of the present invention. The power converter IC 600 is an embodiment of any one of the PMICs with necessary components being external to the IC in FIG. 5.

As compared to the power converter 300 shown in FIG. 3, the Sync communication module 670 in the power converter IC 600 is configured to communicate with another device, for example, an adjacent power converter IC in a multi-phase power supply system (e.g., the multi-phase power supply system 500 shown in FIG. 5) with multiple PMICs stacked (connected in sequence) and communicating with each other in a daisy-chain manner, through corresponding terminals (e.g., terminals TAKE_X and PASS_X). For example, the communication module 670 may include a daisy-chain communication module that can communicate with a daisy-chain communication module of the adjacent PMIC through a daisy-chain-based communication protocol. In another embodiment, the communication module 670 transmits and/or receives signals in a differential manner. For example, the communication module 670 may be coupled to two pair of terminals, and the signals communicated between the adjacent PMICs are transmitted/received in pairs at the paired terminals. The paired signals have equal magnitudes but opposite polarities, and the information to be communicated can be indicated by the difference between these two signals. The description of those modules similar to those in the power converter 300 shown in FIG. 3 are omitted for the sake of brevity.

For example, in a case in which the power converter IC 600 functions as a master device in the multi-phase power supply system (e.g., the multi-phase power supply system 500 shown in FIG. 5) with multiple power converter ICs (i.e., PMICs) communicating with each other in the daisy-chain manner, the I/O communication module 660 is enabled and the power converter IC 600 may directly communicate with the host through the I/O communication module 660. For example, the power converter IC 600, if functioning as the master device, can receive a signal indicating a total number M of the PMICs (i.e., a value of M) in the system or a phase difference between local clocks of every two adjacent PMICs from a host controller directly through the I/O communication module 660 and corresponding terminals SDA and SCL, and transmit the phase difference and its local clock to the next power converter IC through the communication module 670 and corresponding terminal PASS.

In a case in which the power converter IC 600 functions as a slave device in the multi-phase power supply system 500 with multiple power converter ICs (i.e., PMICs) communicating with each other in the daisy-chain manner (for example, the power converter IC 600 is located in the middle of the daisy-chain structure, or at the end of that structure), the I/O communication module 660 may be disabled and the power converter IC 600 may communicate with the host or the other ICs through one or more adjacent PMICs in the daisy-chain manner. For example, the power converter IC 600, if functioning as a slave device, can receive the phase difference and a local clock of the preceding PMIC through the communication module 670 and corresponding terminal TAKE.

While specific embodiments of the present invention have been provided, it is to be understood that these embodiments are for illustration purposes and not limiting. Many additional embodiments will be apparent to persons of ordinary skill in the art reading this disclosure.

What is claimed is:

1. An integrated circuit for a switching power supply, used in a multi-phase power supply system comprising a plurality of the integrated circuits, wherein the integrated circuit comprises:
a first stage input terminal, configured to receive a first stage input voltage;
a first stage output terminal, configured to output a first stage output voltage that is lower than the first stage input voltage, wherein the first stage output terminal is configured to be operable for coupling to first stage output terminals of other integrated circuits in the multi-phase power supply system;
a second stage input terminal, configured to be operable for coupling to the first stage output terminal to receive the first stage output voltage,
a first stage circuit, configured to receive the first stage input voltage through the first stage input terminal, and divide the first stage input voltage to generate the first stage output voltage;
a second stage circuit, configured to receive the first stage output voltage through the second stage input terminal, and regulate the first stage output voltage to generate a second stage output voltage;
a sync communication module, configured to be operable for coupling to a sync communication module of another integrated circuit of the plurality of the integrated circuits in the multi-phase power supply system, and to synchronize a clock signal with the another integrated circuit; and
an I/O communication module, configured to be operable for communicating with a host controller.

2. The integrated circuit according to claim 1, wherein the integrated circuit further comprises a clock module, wherein the clock module comprises a clock generator and a clock shifter.

3. The integrated circuit according to claim 2, wherein
if the integrated circuit is configured as a master device in the multi-phase power supply system, the clock generator is enabled to generate a local clock signal as a reference clock signal, and the clock shifter is disabled, and wherein operation of switches in the first stage circuit of the integrated circuit is controlled by the reference clock signal; and
if the integrated circuit is configured as a slave device in the multi-phase power supply system, the clock generator is disabled, and the clock shifter is enabled to generate a local clock signal,
and wherein operation of switches in the first stage circuit of the integrated circuit is controlled by the local clock signal.

4. The integrated circuit according to claim 3, wherein
if the integrated circuit is configured as the master device, the sync communication module is configured to share the reference clock signal to sync communication modules of the rest of the plurality of the integrated circuits; and
if the integrated circuit is configured as the slave device, the clock shifter is configured to receive the reference clock signal from the master device through corresponding sync communication module and generate the local clock signal by shifting the reference clock signal according to a phase difference and an index of the integrated circuit in the multi-phase power supply system.

5. The integrated circuit according to claim 4, wherein the phase difference is a phase difference between local clock signals of every two adjacent integrated circuits in the multi-phase power supply system.

6. The integrated circuit according to claim 4, wherein the integrated circuit is coupled to the host controller through the I/O communication module to receive a total number of the plurality of the integrated circuits in the multi-phase power supply system and the index of the integrated circuit in the multi-phase power supply system, and configured to obtain the phase difference based on the totally number.

7. The integrated circuit according to claim 3, wherein the plurality of the integrated circuits are configured in a daisy chain and the sync communication module is coupled to the I/O communication module, a take terminal and a pass terminal, and wherein
if the integrated circuit is configured as the master device, the I/O communication module is enabled to receive a total number of the plurality of the integrated circuits in the multi-phase power supply system from the host controller, and wherein the sync communication module is configured to transmit a phase difference and the reference clock to a second integrated circuit adjacent to the integrated circuit through the pass terminal; and
if the integrated circuit is configured as the slave device, the I/O communication module is disabled, and the integrated circuit is configured to receive a preceding local clock signal of a preceding integrated circuit through the take terminal using the sync communication module, calculate the local clock signal by shifting the preceding local clock according to the phase difference, and transmit the local clock signal to a succeeding integrated circuit through the pass terminal using the sync communication module.

8. The integrated circuit according to claim 7, wherein the phase difference is a phase difference between local clock signals of every two adjacent integrated circuits in the multi-phase power supply system.

9. The integrated circuit according to claim 1, wherein the first stage circuit comprises a charge pump using the clock signal to control timing of multiple switches.

10. The power converter according to claim 9, wherein the charge pump is a multiphase charge pump.

11. The power converter according to claim 9, wherein the charge pump is a single-phase charge pump.

12. The power converter according to claim 1, wherein the second stage circuit is a buck converter.

13. A multi-phase power supply system, comprising:
a plurality of integrated circuits, wherein each of the integrated circuits comprises:
a first stage input terminal, configured to receive a first stage input voltage;
a first stage output terminal, configured to output a first stage output voltage that is lower than the first stage input voltage, wherein the first stage output terminals of the plurality of integrated circuits in the multi-phase power supply system are coupled together;
a second stage input terminal, configured to be operable for coupling to the first stage output terminal,
a first stage circuit, configured to receive the first stage input voltage through the first stage input terminal, and divide the first stage input voltage to generate the first stage output voltage;
a second stage circuit, configured to receive the first stage output voltage through the second stage input terminal, and regulate the first stage output voltage to generate a second stage output voltage;
a sync communication module, configured to be operable for coupling to a sync communication module of another integrated circuit of the plurality of the integrated circuits in the multi-phase power supply system, and to synchronize a clock signal with the another integrated circuit;
an I/O communication module, configured to be operable for communicating with a host controller.

14. According to claim 13, the multi-phase power supply system, the integrated circuit further comprises a clock module, wherein the clock module comprises a clock generator and a clock shifter.

15. The multi-phase power supply system according to claim 14, wherein one of the plurality of the integrated circuits is configured as a master device and the rest of the plurality of the integrated circuits are configured as slave devices, and wherein
the clock generator in the master device is enabled to generate a local clock signal as a reference clock signal, and the clock shifter is disabled in the master device, and wherein operation of switches in the first stage circuit of the master device is controlled by the reference clock signal; and
the clock generator in each of the slave devices is disabled, and the clock shifter in each of the slave devices is enabled to generate a local clock signal of the each of the slave devices, and
wherein operation of switches in the first stage circuit of the each of the slave devices is controlled by the local clock signal.

16. The multi-phase power supply system according to claim 15, wherein
the sync communication module of the master device is configured to share the reference clock signal to sync communication modules of the slave devices; and
the clock shifter of each of the slave devices is configured to receive the reference clock signal from the master device and generate the local clock signal of the each of the slave devices by shifting the reference clock signal according to a phase difference and an index of the each of the slave devices in the multi-phase power supply system.

17. The multi-phase power supply system according to claim 16, wherein the phase difference is a phase difference between local clock signals of every two adjacent integrated circuits in the multi-phase power supply system.

18. The multi-phase power supply system according to claim 16, wherein the plurality of integrated circuits are coupled to the host controller through the I/O communication module to receive a total number of the plurality of the integrated circuits in the multi-phase power supply system and the index of the integrated circuit in the multi-phase power supply system, and configured to obtain the phase difference based on the totally number.

19. The multi-phase power supply system according to claim 15, wherein the plurality of the integrated circuits are configured in a daisy chain and the sync communication module of each of the plurality of the integrated circuits is coupled to the I/O communication module, a take terminal and a pass terminal, and wherein
the I/O communication module in the master device is enabled to receive a total number of the plurality of the integrated circuits in the multi-phase power supply system from the host controller, and wherein the sync communication module in the master device is configured to transmit a phase difference and the reference clock to a second integrated circuit adjacent to the master device through the pass terminal; and
the I/O communication modules in the slave device are disabled, and each of the slave devices is configured to receive a preceding local clock signal of a preceding integrated circuit through the take terminal using the sync communication module, calculate the local clock signal by shifting the preceding local clock according to a phase difference, and transmit the local clock signal to a succeeding integrated circuit through the pass terminal using the sync communication module.

20. The multi-phase power supply system according to claim 19, wherein the phase difference is a phase difference between local clock signals of every two adjacent integrated circuits in the multi-phase power supply system.
